(19) United States
(12) Patent Application Publication
(10) Pub. No.: US 2025/0377849 A1
(43) Pub. Date: Dec. 11, 2025

(54) SYSTEM AND METHOD FOR GENERATING A VIRTUAL DISPLAY

(71) Applicant: Booz Allen Hamilton Inc., McLean, VA (US)

(72) Inventors: Brandon Fallin, Lexington Park, MD (US); Paul Carson, California, MD (US); Christopher Alan Earle, California, MD (US)

(73) Assignee: Booz Allen Hamilton Inc., McLean, VA (US)

(21) Appl. No.: 19/229,366

(22) Filed: Jun. 5, 2025

Related U.S. Application Data
(60) Provisional application No. 63/656,885, filed on Jun. 6, 2024.

(51) Int. Cl. G06F 3/14; G06T 19/00

(52) U.S. Cl. CPC G06F 3/1454; G06T 19/006

(57) ABSTRACT

Exemplary systems and methods for generating an extended display include a host computing device having a processor and a physical display device. The host computing device establishes a communication session with an extended reality display device. The host computing device generates plural image frames for output to the physical display device, captures and encode each image frame, and generates a video stream including the encoded image frames. The video stream is transmitted to the at least one extended reality display device for rendering the video stream as a virtual display in an extended reality space about the physical display device.

### RELATED APPLICATION

This application claims priority to U.S. Patent Application No. 63/656,885 filed on Jun. 6, 2024, the entire content of which is hereby incorporated by reference.

### FIELD

The present invention relates to virtual displays, and more particularly to a system and method for generating virtual displays that are rendered using an extended reality device.

### BACKGROUND

Today's military, intelligence, financial, and healthcare professionals must view vast amounts of digital information quickly, securely, and unimpeded. Adding physical displays to a workspace provides more information but increases the risk that information may be observed by nearby individuals without a need-to-know. Furthermore, adding physical displays may prove impossible in certain environments due to space, power, or weight limitations of the end environment. To address the growing needs of users, a solution must provide more information while maintaining confidentiality and operating within the physical constraints of the environment.

With the increase of distributed workforces, there exists a critical need to share visual data in real-time between users. Screen-sharing applications allow users to collaborate, but current implementations force users to reduce their workspace. This occurs as people viewing shared screens must decide where to place the video stream within their existing workspace, often covering up and delaying other work.

### SUMMARY

A system for generating a virtual display is disclosed, the system comprising: at least one host computing device having a processor and a physical display device, the processor executing program code which causes the processor to be configured to establish communication with at least one extended reality display device, generate plural image frames for output to the physical display device, capture and encode each image frame, generate a video stream including the encoded image frames, and transmit the video stream to the at least one extended reality display device for rendering the video stream in an extended reality space.

A method for generating a virtual display is disclosed, the method comprising: establishing, by the host computing device, communication with at least one extended reality display device; generating, by at least one host computing device, plural image frames for output to a physical display device; capturing, by the at least one host computing device, and each image frame; encoding, by the at least one host computing device, each captured image frame; generating a video stream including the encoded image frames; and transmitting, by the host computing device, the video stream to the at least one extended reality display device for rendering the video stream in an extended reality space.

A non-transitory computer readable medium encoded with program code for generating a virtual display is disclosed, wherein when placed in communicable contact with at least one processor, the computer readable medium causing the at least one processor to be configured to: at a host computing device: establish communication with at least one extended reality display device; generate plural image frames for output to the physical display device; capture and encode each image frame; generate a video stream including the encoded image frames; and transmit the video stream to the at least one extended reality display device for rendering the video stream in an extended reality space.

### DESCRIPTION OF THE DRAWINGS

Exemplary embodiments are best understood from the following detailed description when read in conjunction with the accompanying drawings. Included in the drawings are the following figures:

FIGS. 1A-1C illustrate a system architecture according to an exemplary embodiment of the present disclosure.

FIG. 2 illustrates a software and hardware configuration according to an exemplary embodiment of the present disclosure.

FIG. 3 illustrates an exemplary host computing device according to an exemplary embodiment of the present disclosure.

FIG. 4 illustrates a system having multiple extended reality devices according to an exemplary embodiment of the present disclosure.

FIG. 5 illustrates a system having multiple host computing devices according to an exemplary embodiment of the present disclosure.

FIG. 6 illustrates a system having multiple host devices and multiple extended reality display devices according to an exemplary embodiment of the present disclosure.

FIG. 7 illustrates a method for rendering a virtual display according to an exemplary embodiment of the present disclosure.

FIG. 8 illustrates a hardware configuration of a computing device according to an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

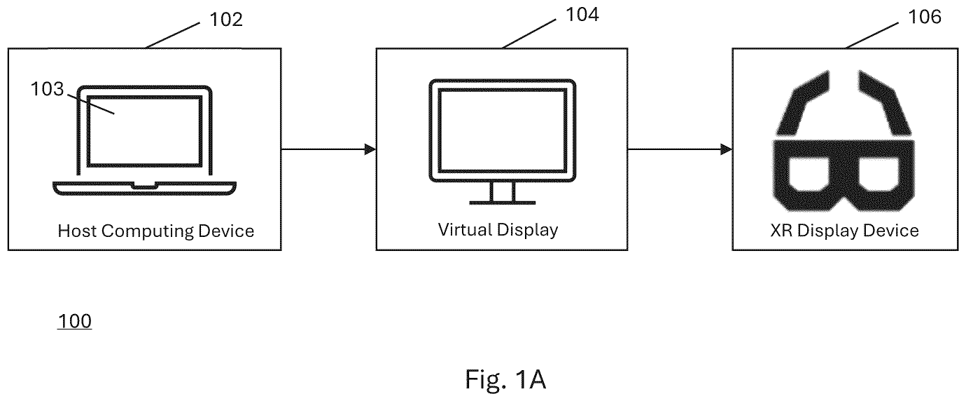

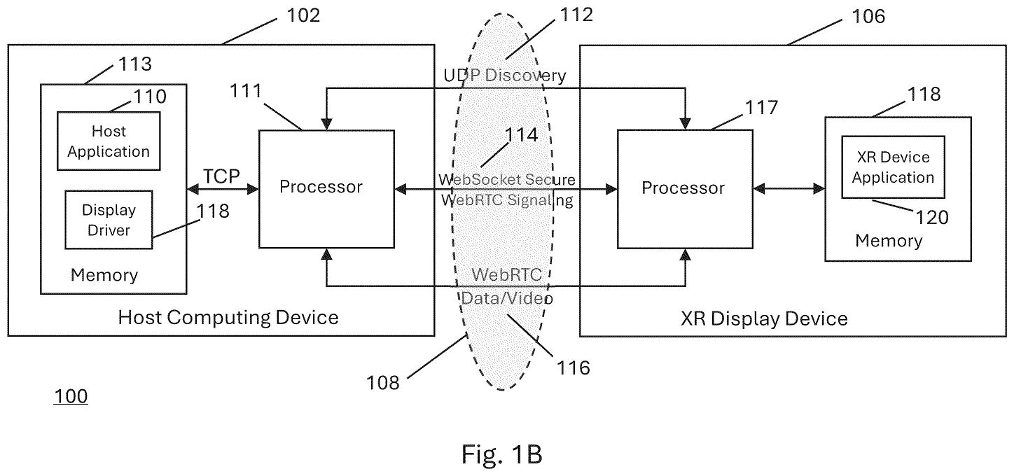

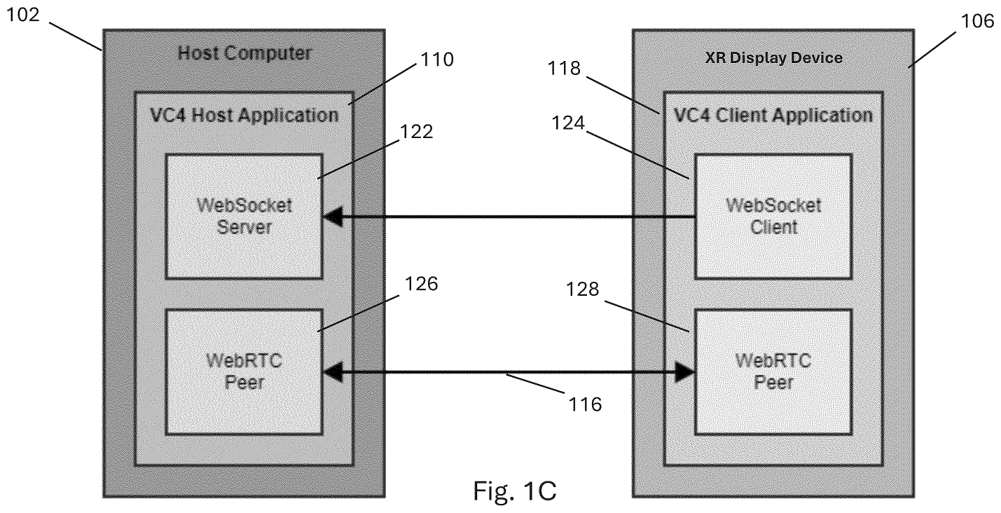

The system described herein includes a combination of hardware and software components which provide an agnostic solution that allows users to create virtual displays and render them within extended reality display devices. According to exemplary embodiments disclosed herein, the XR display devices can render the virtual displays using virtual reality, augmented reality, or a combination of both. FIGS. 1A-1C illustrate a system architecture according to an exemplary embodiment of the present disclosure. As shown in FIG. 1A, the system 100 includes a host device 102, a virtual display 104, and an XR display device 106. The host device 102 can be a computing device such as a desktop, laptop, tablet, or other suitable processing device configured for generating the virtual display 104. According to an exemplary embodiment, the host computing device 102 can be connected to a physical display device 103 configured to output visual information in the form of text, images, video or other suitable format as desired. The physical display device 103 can include at least one display screen, monitor, or other device suitable for displaying information and/or visually interacting with a user. According to exemplary embodiments, the host computing device 102 can be further configured to establish communication with a user interface as WebRTC peers to allow a user to control operation and functions associated with the rendering of video content on one or more virtual displays 104.

As shown in FIG. 1B, the host computing device 102 can include a processor 111 and memory 113. The memory 113 can store a host application 110 and a display driver 118 used for generating the virtual displays 104. The processor 111 can execute the host application 110, which further configures the processor to create one or more virtual displays on the host computing device 102. The processor 111 can capture the output of the one or more virtual displays 104 for encoding and transmitting to one or more virtual display devices 106 using a suitable communication protocol over a local network 108. For example, the processor 111 can execute the display driver 118 to generate a virtual display 104 as video streaming data that includes plural image frames for output to the XR display device 106. Through the display driver 118, the processor 111 can capture and encode each image frame of the virtual display 104 and generate a video stream that includes the plural image frames. The host computing device 102 can transmit the video stream to the XR display device 106 via the WebRTC channel 116 over the local network 108 to render the virtual display 104.

The XR display device 106 can be an extended reality (XR) headset device or any other suitable device that is configured to include and execute a software component for rendering virtual display content received from the host computing device 102. According to an exemplary embodiment, the XR display device 106 could be replaced with any device that is configured to receive and/or process the video data encoded for generating the virtual display 104. For example, the device for receiving the video streaming data can include a device configured to record the video to disk, retransmit the video to another device, render the video streaming data, discard the video streaming data after a specified period, or perform another operation on the video streaming data as desired.

The host application 110 can further configure the host computing device 102 to establish a communication session with the XR display device 106 over a local network 108. For example, via the host application 110, the host computing device 102 can broadcast a transport protocol 112, such as a User Datagram Protocol (UDP), for discovering other client devices, such as an XR display device 106, on the local network 108. The host computing device 102 can be further configured to initiate a WebSocket session 114 to facilitate WebRTC signaling between the host application and an application executing on the XR display device 106. WebRTC is a known communication technology that provides for the streaming of encrypted data including video, audio, and generic data to connected devices over the local network 108. As a result of the WebRTC signaling, and through further handshaking operations as will be discussed further, the host computing device 102 can establish a WebRTC peer session 116 with a XR display device 106 for streaming video data to the XR display device 106. Once connection with the XR display device 106 is established the host computing device 102 can wirelessly transfer data/video to the XR display device 106 over the local network 108. The host computing device 102 is configured to use the display driver 118 to instantiate a virtual display by capturing image frames from displays on the host machine and encode them to a WebRTC peer channel established with the XR display device 106. For example, the processor 111 can establish a transmission control protocol (TCP) client into a virtual display adaptor.

As shown in FIG. 1C, upon execution of the device application 118 stored in memory 120 by the processor 117, the XR display device 106 can be further configured to send a WebSocket request to the host computing device 102 for establishing a WebSocket Client that can respond to UDP discovery requests 112 from the host computing device 102. As shown in FIG. 1C, a WebSocket session can be established between the host computing device 102 and the XR display device 106 after the host computing device 102 discovers the XR display device 106. According to an exemplary embodiment, the host application 110 can configure the host computing device 102 to operate as a WebSocket server 122. Further, the XR display device can be configured, via the XR device application 118, to operate as a WebSocket client 124 on the with the host computing device is established. As a result of the WebSocket signaling 114, the host computing device 102 and the XR display device 106 can establish a WebRTC communication channel 116 and can communicate over the WebRTC channel 116 as WebRTC Peers 126, 128 for sending/receiving of video frames. As WebRTC peers, the host computing device 102 and the XR display device 106 can communicate directly with one another to share multimedia streams of audio, video, or other suitable multimedia data as desired.

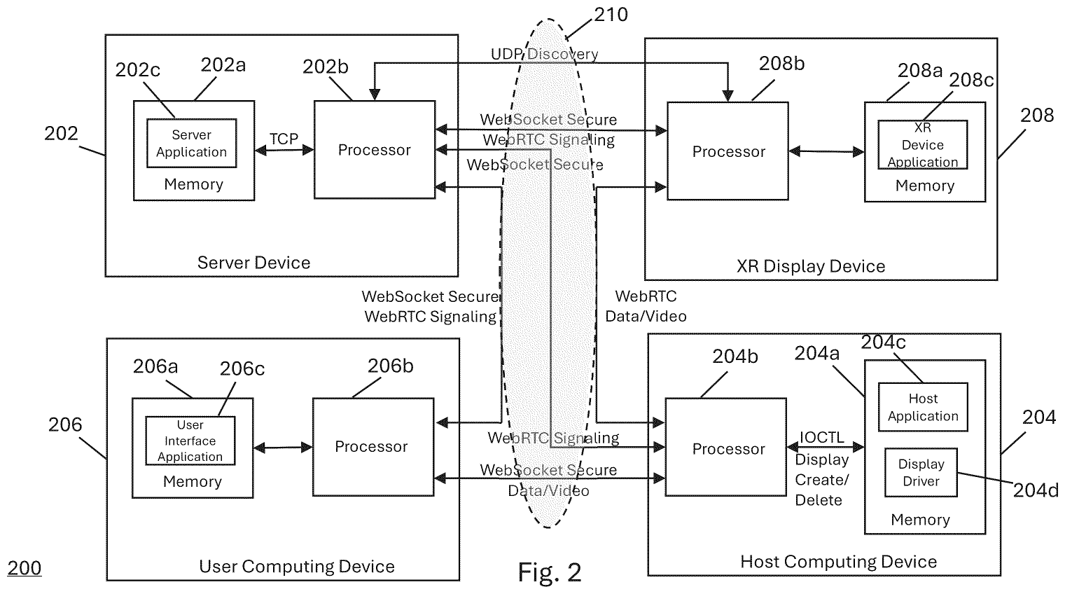

FIG. 2 illustrates a software and hardware configuration according to an exemplary embodiment of the present disclosure.

The system 200 includes a server device 202, a host computing device 204, a user device 206, and a XR display device 208 each of which includes a processor and memory for executing a software application for performing operations for generating video frames or rendering a virtual display from the video frames, where applicable as disclosed herein. For example, memory 202a of the server device 202 stores programming code for a server application 202c. When executed by the processor 202b, the server application 202c configures the server device 202 to operate as a central software node for the local network 108 and relays connection information between the connected devices components so that they may establish direct peer-to-peer communications. The connected devices include the host computing device 204, the user device 206, and the XR display device 208. The server device 202, via the server application 202c, is configured to establish communication with client devices 204, 206, 208, which include the host computing device 204, the user device 206, and the XR display device 208 by broadcasting a UDP. The server device can establish bi-directional Websocket communication with each of the client devices 204, 206, 208 by monitoring (e.g., listening) the local network 108 for incoming connections from one or more of the client devices 204, 206, 208. The server device 202 can be configured as a central relay that facilitates WebRTC signaling between the server application 202c, the host computing application 204c, the user interface application 206c, and the XR device application 208c. As a result, the server device 202 is configured to centralize peer discovery and connection requests associated with the local network 210, such that the server device 202 is configured to audit and authorize connection requests with other devices before connection can be established. In addition, the server device 202 can be configured to provide control over the other nodes of the system, allowing the management of streams from a centralized location.

The memory 204a of the host computing device 204 stores programming code for the host application 204c. When executed by the processor 204b, the host application 204c configures the host computing device 204 to use a display driver 204d to instantiate a virtual display, capture a display output, and transmit video streams to the XR display device 208. According to an exemplary embodiment the host computing device 204 can be configured to operate as a server such that the operations of the server device 202 and the host computing device 204 can be integrated into one device.

The memory 206a of the user computing device 206 stores programming code for the user interface application 206c. When executed by the processor 206b, the user interface application 206c configures the user computing device 206 to generate a graphical user interface so that the user can interact with and control the functionality of the system 200.

The memory 208a of the XR display device 208 stores programming code for the XR device application 208c. When executed by the processor 208b, the XR device application 208c configures the XR display device 208 to receive video streams and render virtual displays from the video streams for the user within an extended reality (XR) space.

Each of the client devices 204, 206, 208 can connect to the server computing device 202 as it is monitoring the local network 210. Once the host computing device 204, the user device 206, and the XR display device 208 are connected to the local network 210 via the Websocket, each device is configured to negotiate communication routes with the other devices (e.g., the host computing device 204, the user device 206, and the XR display device 208) on the local network 210 to establish a WebRTC peer and peer communication channel. According to an exemplary embodiment, the negotiation is handled through each device (e.g., the host computing device 204, the user device 206, and the XR display device 208) exchanging Interactive Connectivity Establishment (ICE) candidates which represent the network information (e.g., network address) for a given peer to establish an RTC session. In addition, information exchange can include security information such as a classification level, security level, or authorization level (e.g., associated with the device and/or a user) needed for access to the video content. This information is exchanged back and forth between pairs of peers until both peers agree upon a route to use to facilitate communication. In the event, a client device does not have the classification level needed to access the information, the communication session is not established and/or the access to the video content is denied. Based on this operation, the local network 210 can be formed based on the security level of information that will be communicated by the host computing devices and the matching level of access associated with the XR display devices. The ICE candidates are exchanged between the server application 202c and each of the client apps (e.g., the host computing application 204c, the user interface application 206c, and the XR device application 208c) through the established WebSocket connection. Once a route is agreed upon through exchanging ICE candidates, WebRTC peers (the server device 202, the host computing device 204, the user device 206, and the XR display device 208) may continue and establish a session between the peers where they may exchange real-time data through multimedia streams. According to an exemplary embodiment, access to multimedia streams can be controlled on a stream-by-stream basis such that each client device on a local network must present the proper credentials (e.g., access/security level) to receive a multimedia stream. The credentials can be presented through user-provided biometric information, password, or other suitable test or prompt as desired. These multimedia streams can be added as part of the connected session and the information of which can be exchanged via Session Description Protocol (SDP) or any other suitable communication protocol for negotiating the specified settings for a media stream as desired. Each WebRTC uses the SDP to gather information on which multimedia streams are available for use. This information is exchanged between server device 202, the server device 202, the host computing device 204, the user device 206, and the XR display device 208 through the established WebSocket connection. Websocket connections allow for the communication of IP enabled video streams. As a result, the system disclosed herein is agnostic to the type of transport layer used to transmit video and supports both tethered (i.e., wired) and untethered (i.e., wireless) deployments using ethernet or Wi-Fi connections, respectively. Furthermore, the operation of the XR display device can be configured based on a 3D gaming engine and open source extended reality platform. As a result, the system can communicate and provide operation across multiple platforms such that deployment in an environment including a standalone XR device, host computing system, large-scale enterprise, or environment of any scale can be effected.

Each client device 204, 206, 208 can be notified when another client device such as a user device or host computing device is broadcasting video content on the local network 210. One or more client devices 204, 206, 208 can send to any host device on the network for accessing the video content. The requesting client device and the host computing device can go through the WebRTC signaling to establish a communication session.

According to an exemplary embodiment, all communication on the local network 210 other than the video stream can use a JavaScript objection notation (JSON), protobuf format, or other suitable message format to exchange data between endpoints.

The distributed architecture of the system 200 enables the centralized management of the virtual displays within a local network. All communication between the client devices, which are configured as distributed nodes, can be initiated by the server device 202 running the server application 202c. As a result, the server device 202 provides a central relay in the system that is established prior to WebRTC peers being discovered and peer-to-peer connections being established. This centralized routing of peer discovery and connection requests provided by the server application 202c allows the server device 202 to function as a central location for auditing and authorizing connection requests before they may be established. Furthermore, the server application 202c can be extended to provide control over the other nodes 204, 206, 208 of the system 200 to allow the management of streams from a centralized location.

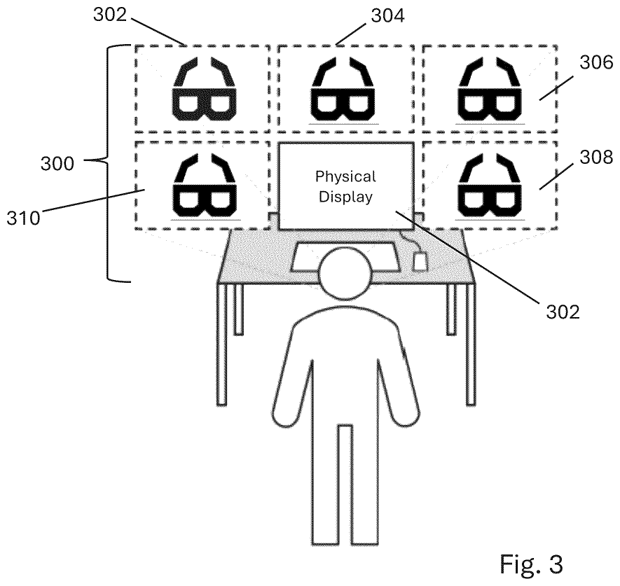

FIG. 3 illustrates an exemplary host computing device according to an exemplary embodiment of the present disclosure. As shown in FIG. 3, a host computing device 300 can be configured as a desktop with one physical display 302. The host computing device 300 can be configured with the host application such that multiple XR video streams can be generated. For example, the host computing device 300 can be configured to encode video data to generate a video stream for rendering as a virtual display. The software and/or hardware components of the host computing device can convert the video data into a compressed format for efficient streaming and communication within a specified communication framework, such as WebRTC, as already discussed. According to an exemplary embodiment, the host computing device can include video codecs such as H.264, VP8, and VP9, or any other suitable video encoder as desired. In addition, the video streams can be sent to an external device, such as a XR display device 106 where they can be rendered as virtual displays 304, 306, 308, 310 for viewing by a user, as already discussed. The arrangement of the multiple virtual displays 304, 306, 308, 310 about the physical display 302 can be controlled through the user interface (not shown). As shown in FIG. 3, physical display 302 of the host computing device 300 can be extended beyond the physical limitations of their environment. According to exemplary embodiments disclosed herein, each display can only be rendered through one or more XR display devices 106, 208 and do not occupy any physical space in the real world. As a result, the exemplary system disclosed herein provides a secure viewing platform in which virtual displays may only be viewable by authorized users of a XR display device 106, 208. As such, the exemplary embodiments described herein resolve issues associated with physical space limitations and security concerns from unauthorized observance of sensitive data.

The virtual displays 304, 306, 308, 310 enable high performance graphical output and can render high fidelity graphical applications above 4K resolution with a frame rate of 60 frames per second. In addition, the host computing device 102 can be configured to recognize each virtual display instance as a fully featured display, complete with unique Extended Display Identification Data (EDID) values, which can enable resizing, positioning, and re-positioning of each virtual display according to a user's preference and control.

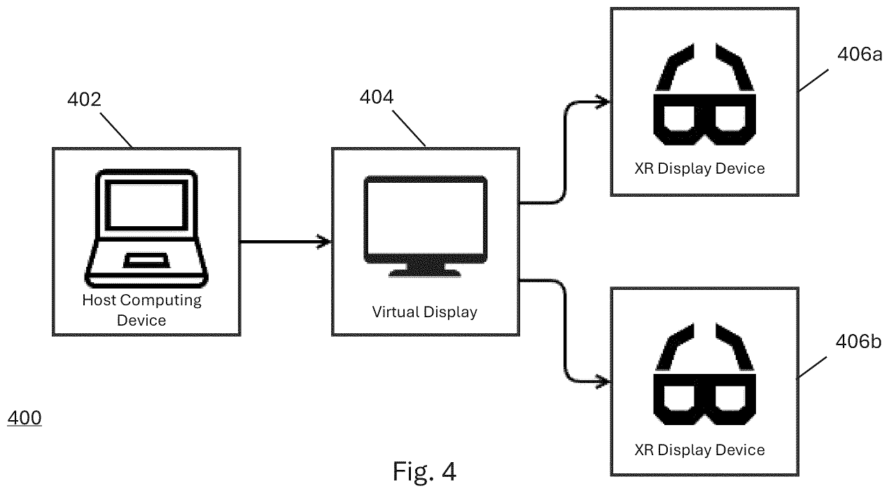

FIG. 4 illustrates a system having multiple extended reality devices according to an exemplary embodiment of the present disclosure. As shown in FIG. 4, the system 400 includes a host computing device 402 that is configured to generate a video stream as a virtual display 404. The virtual display 404 can be rendered by two XR display devices 406a and 406b. That is, the XR display devices 406a and 406b can render the same virtual display instance 404 generated by a single host computing device 402. As a result of this configuration, multiple users of the system 400 can simultaneously view the same video stream, such that a single virtual display can be shared between users in an XR space.

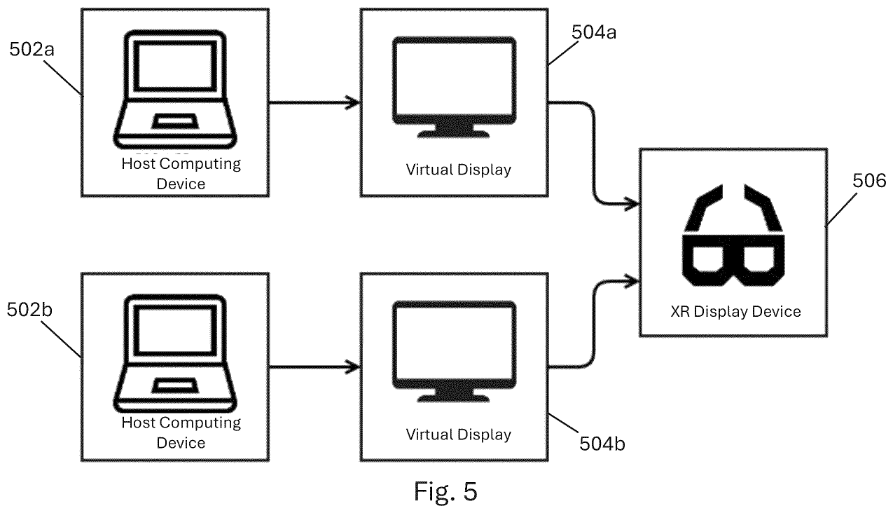

FIG. 5 illustrates a system having multiple host computing devices according to an exemplary embodiment of the present disclosure. The system 500 can include multiple host computing devices 502a and 502b. Each host computing device 502a, 502b can instantiate separate virtual displays 504a, 504b, which can be rendered to the same XR display device 506. As a result of this configuration, a single virtual display device can be used to simultaneously separate virtual displays that are generated from different host devices.

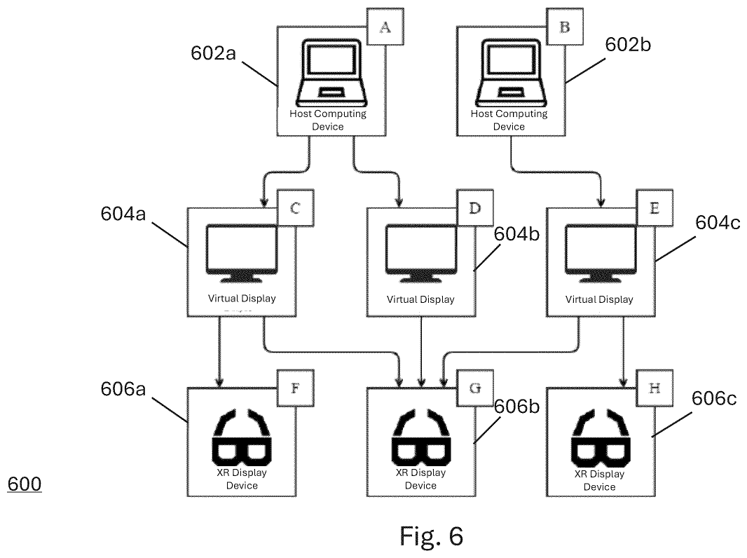

FIG. 6 illustrates a system having multiple host devices and multiple extended reality display devices according to an exemplary embodiment of the present disclosure. The system 600 can include multiple host computing devices 602a, 602b that can each instantiate and stream multiple virtual displays 604a, 604b, 604c. The system also includes multiple XR display devices 606a, 606b, 606c. As shown in FIG. 6, each XR display device can render any one or combination of the virtual displays 604a, 604b, 604c simultaneously.

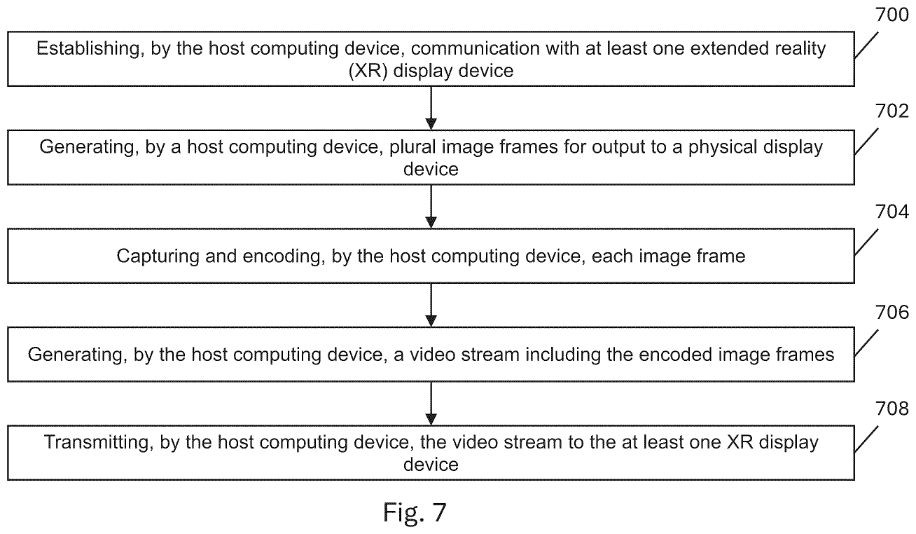

FIG. 7 illustrates a method for rendering a virtual display according to an exemplary embodiment of the present disclosure. As already discussed, the host computing device 102, 202 can store programming code for a host application in memory. The host application can be executed by the processor which causes the host computing device to generate one or more virtual displays that can be rendered by the XR display device. Upon execution of the programming code by the processor, the host computing device can be configured to perform operations which include in Step 700, establishing communication with at least one XR display device 106. As already discussed, the communication can include WebRTC signaling to establish a WebRTC peer communication session with the at least one XR display device. The host computing device 102 further performs Step 702 for generating plural image frames for output to a physical display device. In Step 704, the host computing device captures and encodes the image frames to generate a video stream which includes the encoded image frames (Step 706). The host computing device then transmits the video stream to the at least one XR display device 106 so that the video stream can be rendered in one or more virtual displays of an extended reality space about a physical display device of a client device (Step 708).

The exemplary systems and methods described herein can provide solutions to cybersecurity and distributed workspace problems of various computing environments and platforms. More specifically, the Websocket and WebRTC protocols and/or formats can provide greater privacy when viewing and/or communicating multimedia information, the availability of an unlimited number of viewable content displays, increased portability over physical monitors or displays, flexibility in size and shape of monitors, an ability to position and/or arrange monitors anywhere in a 360-degree field of view, reduced power consumption in mobile environments, reduced physical weight and space requirements for system, greater situational awareness in fast-paced or stressful environments.

In addition, the exemplary systems and methods provide: a more user-centric approach to cybersecurity; a cross-platform, equipment-agnostic application that result in a secure working environment without proprietary computers or XR display devices; operations that rely on device-installed applications, which avoid the security risks of a cloud-based environment; and a system that is configurable according to user-specified needs.

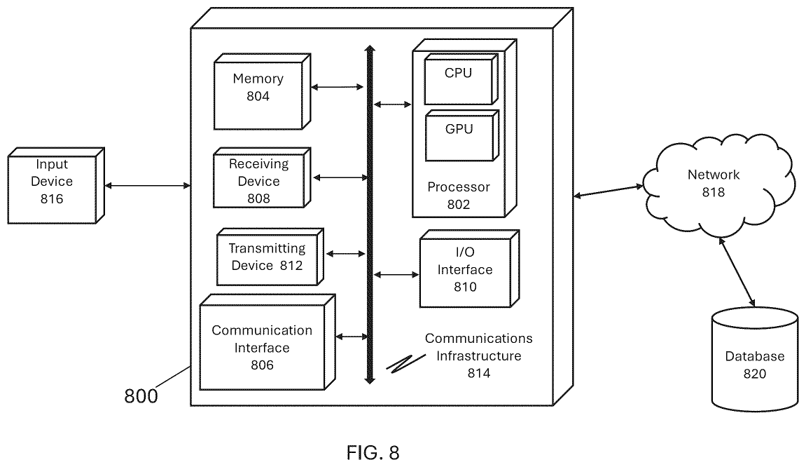

FIG. 8 illustrates a hardware configuration of a computing device (server device, host device, client device) according to an exemplary embodiment of the present disclosure. As shown in FIG. 8, the computing system/device 800 may include a processor (e.g., CPU) 802 and memory 804. The processor 802 may execute software instructions (e.g., program code) for mitigating interference in a radio network. The computing system/device 800, as disclosed herein, can be configured for generating one or more virtual displays in combination with the software instructions.

The processor 802 may be implemented in hardware, software, or a combination of hardware and software. For example, the processor 802 may include a Reduced Instruction Set Core (RISC) processor, a CISC microprocessor, a Microcontroller Unit (MCU), a CISC-based Central Processing Unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. The hardware of such devices may be integrated onto a single substrate (e.g., silicon “die”), or distributed among two or more substrates. Various functional aspects of the processor 802 may be implemented solely as software or firmware associated with the processor 802.

The memory 804 can include a volatile or non-volatile, transitory, or non-transitory memory, and be embodied as an in-memory, an active memory, a cloud memory, etc. Examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor. Memory 804 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices, such as optical storage (e.g., a compact disc, digital versatile disc, Blu-ray disc, etc.), magnetic tape storage (e.g., a hard disk drive), or a solid-state drive.

The term “computer-readable medium” (or “machine-readable medium”) as used herein is an extensible term that refers to any medium or any memory, which participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine-readable medium can be configured to store one or more instructions thereon. The instructions can be in the form of algorithms, program logic, etc. that cause the processor to execute any of the functions disclosed herein.

Software instructions may be read into memory 804 from another computer-readable medium or from another device via a communication interface with a computing device. When executed, software instructions stored in memory may cause the processor to perform one or more processes described herein. Embodiments described herein are not limited to any specific combination of hardware circuitry and software.

The processor 802 can include one or more processing or operating modules. A processing or operating module can be a software or firmware operating module configured to implement any of the functions disclosed herein. The processing or operating module can be embodied as software and stored in memory 804. The memory 804 being operatively associated with and communicably coupled to the processor 802. A processing module can be embodied as a web application, a desktop application, a console application, or other suitable application as desired.

Embodiments of the memory 804 can include a processor module and other circuitry to allow for the transfer of data to and from the memory, which can include to and from other components of a communication system. This transfer can be via hardwired or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data (including an operating system) generated and/or used by the exemplary computing device (e.g., in the memory) can be stored on any type of suitable computer readable media.

In an exemplary embodiment, the data can be configured in any type of suitable database configuration, such as a relational database, a structured query language (SQL) database, a distributed database, an object database, etc. According to an exemplary embodiment, the data can be stored on one or more device configured to operate as cloud storage on a network. Suitable configurations and storage types will be apparent to people who have skill in the relevant art.

The exemplary computing device 800 can also include a communications interface 806. The communications interface 806 can be configured to allow software and data to be transferred between the computing device and external devices. Exemplary communications interfaces 806 can include a modem, a network interface (e.g., an Ethernet card), a communications port, a PCMCIA slot and card, etc. Software and data transferred via the communications interface 806 can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be a means for providing software to the computing device. Computer programs (e.g., computer control logic) can be stored in the memory. Computer programs can also be received via the communications interface 806. Such computer programs, when executed, can enable the computing device to implement the present methods as discussed herein. In particular, the computer programs stored on a non-transitory computer-readable medium, when executed, can enable the hardware processor to implement the methods as discussed herein. Accordingly, such computer programs can represent controllers of the computing device.

According to exemplary embodiments described herein, the combination of the memory 804 and the processor 802 can store and/or execute computer program code for performing the specialized functions described herein. The program code can be stored on a non-transitory computer readable medium, such as the memory devices for the computing device, which may be memory semiconductors (e.g., DRAMs, etc.) or other tangible and non-transitory means for providing software to the computing device. For example, via any known or suitable service or platform, the program code can be deployed (e.g., streamed and/or downloaded) remotely from computing devices located on a local-area or wide-area network and/or in a cloud-computing arrangement or environment. In another example, the computer programs (e.g., computer control logic) or software may be stored in memory resident on/in the computing device. The computer programs or software may be stored in a computer program product or non-transitory computer readable medium and loaded into the computing device using any one or combination of a removable storage drive, an interface for internal or external communication, and a hard disk drive, where applicable. The computer programs or software, when executed, may enable the computing device to implement the present methods and exemplary embodiments discussed herein. Accordingly, such computer programs may represent controllers of the computing device.

The computing system 800 or device may also include a receiver or receiving device 808, an input/output (I/O) interface 810, a transmitting device 812, a communication infrastructure 814, an input device 816, a communication network 818, and a database 820.

The receiver or receiving device 808 may be a combination of hardware and software components configured to receive data samples from the mobile network or database. According to exemplary embodiments, the receiving device 808 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. The receiving device 808 can be an input device for receiving signals and/or data samples formatted according to 3GPP protocols and/or standards. The receiving device 808 can be connected to other devices via a wired or wireless network or via a wired or wireless direct link or peer-to-peer connection without an intermediate device or access point. The hardware and software components of the receiving device 808 can be configured to receive the data from the mobile network according to one or more communication protocols and data formats. For example, the receiving device 808 can be configured to communicate over a network 820, which may include a local area network (LAN), a wide area network (WAN), a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, the receiving device 808 can be configured to identify parts of the received data via a header and parse the data signal and/or data packet into small frames (e.g., bytes, words) or segments for further processing at the processor.

The I/O interface 810 can be configured to receive the signal from the processor and generate an output suitable for a peripheral device via a direct wired or wireless link. The I/O interface 810 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

The transmitting device 812 can be configured to receive data from the processor and assemble the data into a data signal and/or data packets according to the specified communication protocol and data format of a peripheral device or remote device to which the data is to be sent. The transmitting device 812 can include one or more hardware and software components for generating and communicating the data signal over the communications infrastructure and/or via a direct wired or wireless link to a peripheral or remote device. The transmitting device 812 can be configured to transmit information according to one or more communication protocols and data formats as discussed in connection with the receiving device.

The input device 816 is configured to receive an input from a user for processing and/or use by the CPU 802. For example, the input device 818 can be implemented as a physical or virtual keyboard, a physical or virtual touchpad, a microphone, or any suitable device for inputting data or information as desired. The input device 816 can be configured to format the received user input suitable for use by the CPU 802 or be configured to provide the user input to the I/O interface 810 for further processing. According to an exemplary embodiment, the input device 816 can be configured to communicate wirelessly with the computing system 800 or be integrated into the housing of the computing system 800 or have a physical connection to the computing device 800. In performing the described operations, the input device 816 can be configured to include a combination of hardware and software components.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower-level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the system to perform the functions disclosed herein. It will be apparent to persons having skill in the relevant art that such processes result in the system being a specially configured computing device uniquely programmed to perform the functions of the exemplary embodiments described herein.

It will be appreciated by those skilled in the art that the present disclosure can be embodied in other specific forms without departing from the spirit or essential characteristics thereof. The presently disclosed embodiments are therefore considered in all respects to be illustrative and not restrictive. The scope of the disclosure is indicated by the appended claims rather than the foregoing description, and all changes that come within the meaning, range, and equivalence thereof are intended to be embraced therein.

What is claimed is:

1. A system for generating a virtual display, the system comprising:
a host computing device having a processor and a physical display device, the processor executing program code which causes the processor to be configured to:
establish communication with at least one extended reality display device;
generate plural image frames for output to the physical display device;
capture and encode each image frame;
generate a video stream including the encoded image frames; and
transmit the video stream to the at least one extended reality display device for rendering the video stream in an extended reality space.

2. The system of claim 1, wherein the at least one extended reality display device includes one or more extended reality headsets, wherein each extended reality headset is configured to receive the rendered video stream from the host computing device and a render a same virtual display in the extended reality space about the physical display device.

3. The system of claim 1, wherein the host computing device, is a first host computing device, the system comprising:
one or more additional host computing devices, wherein each additional host computing device is configured to:
render separate video streams into one or more virtual displays in the extended reality space about the physical display device; and
transmit the separate rendered video streams to the at least one extended reality headset.

4. The system of claim 1, wherein the host computing device is configured to:
generate and render plural video streams from the encoded image frames, each rendered video stream including one or more virtual displays in the extended reality space about the physical display device; and
transmit each rendered video stream to the at least one extended reality display device in an Internet protocol format.

5. The system of claim 1, comprising:
at least one user device configured to generate a graphical user interface for controlling the generation of the video stream by the host computing device and the rendering of the one or more extended displays by the host computing device.

6. The system of claim 5, comprising:
a server configured to manage a secure network connection between the host computing device, the at least one extended reality display device, and the at least one user device.

7. The system of claim 6, wherein the server is configured to audit and authorize connection requests by the at least one user device, the host computing device, and the at least one extended reality display device.

8. The system of claim 7, wherein the at least one user device includes plural user devices, and the server is configured to provide peer-to-peer connection between at least two of the plural user devices.

9. The system of claim 1, wherein the host computing device is configured to transmit the rendered video stream to the at least one extended reality display device using an Internet protocol for wireless communication.

10. The system of claim 1, wherein the host computing device is configured to transmit the rendered video stream to the at least one extended reality display device using an Internet protocol for wired communication.

11. A method for generating a virtual display, the method comprising:
establishing, by the host computing device, communication with at least one extended reality display device;
generating, by a host computing device, plural image frames for output to a physical display device;
capturing and encoding, by the host computing device, each image frame;
generating, by the host computing device, a video stream including the encoded image frames; and
transmitting, by the host computing device, the video stream to the at least one extended reality display device for rendering the video stream in an extended reality space.

12. A non-transitory computer readable medium encoded with program code for generating a virtual display, which when placed in communicable contact with at least one processor, the computer readable medium causing the at least one processor to be configured to:
establish communication with at least one extended reality display device;
generate plural image frames for output to the physical display device;
capture and encode each image frame;
generate a video stream including the encoded image frames; and
transmit the rendered video stream to the at least one extended reality display device for rendering the video stream in an extended reality space.
